(19) United States
(12) Patent Application Publication
(10) Pub. No.: US 2009/0240695 A1
(43) Pub. Date: Sep. 24, 2009

(54) UNIQUE COHORT DISCOVERY FROM MULTIMODAL SENSORY DEVICES

(75) Inventors: Robert Lee Angell, Salt Lake City, UT (US); Robert R. Friedlander, Southbury, CT (US); James R. Kraemer, Santa Fe, NM (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/050,537

(22) Filed: Mar. 18, 2008

(51) Int. Cl. G06F 17/30; H04Q 5/22; H04N 5/225; G08B 17/00

(52) U.S. Cl. 707/7; 340/10.1; 348/207.1; 340/584; 707/E17.001; 348/E05.024

(57) ABSTRACT

According to one embodiment of the present invention, a computer implemented method, apparatus, and computer-usable program product for generating unique cohort groups using multimodal sensory device. Multimodal sensory data is received from a set of multimodal sensors in a public environment. The set of multimodal sensors are associated with a network. The multimodal sensory data is received from the set of multimodal sensors over the network. The multimodal sensory data is processed to generate a plurality of attributes to form cohort attributes. A plurality of unique cohort groups is generated using the cohort attributes and the multimodal sensory data. Each member of the cohort group shares at least one common attribute.

### BACKGROUND OF THE INVENTION

1. Field of the Invention

The present invention is related generally to an improved data processing system, and in particular to a method and apparatus for processing multimodal sensor data. More particularly, the present invention is directed to a computer implemented method, apparatus, and computer usable program code for generating unique cohort groups using sensory data gathered by multimodal sensor devices.

2. Background Description

A cohort is a group of people or objects that share common characteristics or experience. For example, a group of people born in 1980 may form a birth cohort. A cohort may include one or more sub-cohorts. For example, the birth cohort of people born in 1980 may include a sub-cohort of people born in 1980 in Salt Lake City, Utah. A sub-subcohort may include people born in 1980 in Salt Lake City, Utah to low income, single parent households.

Cohort groups are generated based on one or more characteristics of the members of the cohort groups. The information used to identify the characteristics of members of the cohort groups, are typically provided by the members of the cohort groups. However, this information describing characteristics and attributes of members of cohort groups may be voluminous, dynamically changing, and/or unknown to the member of the cohort group. Thus, it may be difficult and time consuming for an individual to access all the information necessary to generate unique cohort groups. Moreover, unique cohort groups are typically sub-optimal because individuals lack the skills, time, knowledge, and/or expertise needed to gather cohort attribute information.

### BRIEF SUMMARY OF THE INVENTION

According to one embodiment of the present invention, a computer implemented method, apparatus, and computer usable program product for generating unique cohort groups using multimodal sensory device. Multimodal sensory data is received from a set of multimodal sensors in a public environment. The set of multimodal sensors are associated with a network. The multimodal sensory data is received from the set of multimodal sensors over the network. The multimodal sensory data is processed to generate a plurality of attributes to form cohort attributes. A plurality of unique cohort groups is generated using the cohort attributes and the multimodal sensory data. Each member of the cohort group shares at least one common attribute.

### BRIEF DESCRIPTION OF THE SEVERAL VIEWS OF THE DRAWINGS

FIG. 1 is a block diagram of a network of data processing systems in which illustrative embodiments may be implemented;

FIG. 2 is a block diagram of a data processing system in which illustrative embodiments may be implemented;

FIG. 3 is a block diagram of a set of multimodal sensors located in a plurality of locations in accordance with an illustrative embodiment;

FIG. 4 is a block diagram of a data processing system for generating unique cohort groups using multimodal sensor data in accordance with an illustrative embodiment;

FIG. 5 is a block diagram of a set of multimodal sensors in accordance with an illustrative embodiment;

FIG. 6 is a block diagram of a sensor in a set of multimodal sensors in accordance with an illustrative embodiment;

FIG. 7 is a block diagram of a video analysis system in accordance with an illustrative embodiment;

FIG. 8 is a block diagram of a radio frequency identification tag reader for gathering data associated with one or more cohorts is shown in accordance with an illustrative embodiment;

FIG. 9 is a block diagram of a cohort generation engine in accordance with an illustrative embodiment;

FIG. 10 is a block diagram of unique cohort groups in accordance with an illustrative embodiment;

FIG. 11 is a block diagram of a pedestrian cohort group in accordance with an illustrative embodiment;

FIG. 12 is a block diagram of another pedestrian cohort group generated using multimodal sensory data in accordance with an illustrative embodiment; and

FIG. 13 is a flowchart illustrating a process for generating unique cohort groups using multimodal sensory data transmitted over a network in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

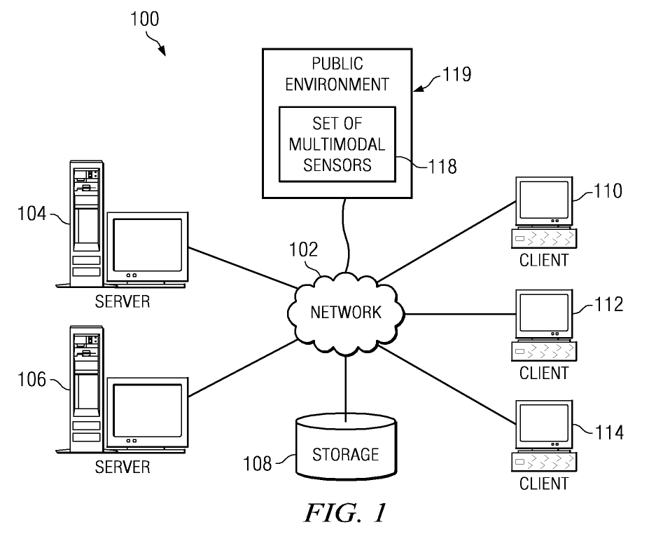

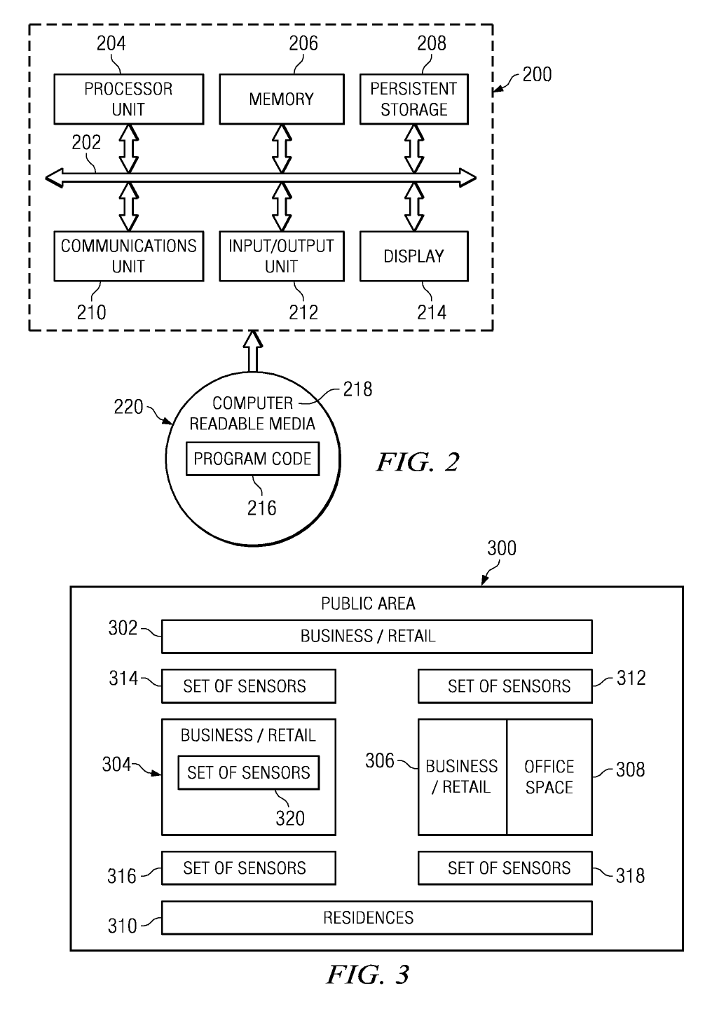

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example.

Set of multimodal sensors 118 is a set of one or more multimodal sensor devices for gathering information associated with one or more members of a cohort group. A multimodal sensor is an actuator and/or sensor capable of generating sensor data and transmitting the sensor data to a central data processing system, such as data processing system 100 in FIG. 1. Set of multimodal sensors 118 are located in public environment 119. Public environment 119 is any environment that is publicly owned, accessible to the public, and/or within the view of the public.

Set of multimodal sensors 118 may include, without limitation, one or more global positioning satellite receivers, infrared sensors, microphones, motion detectors, chemical sensors, biometric sensors, pressure sensors, temperature sensors, metal detectors, radar detectors, photosensors, seismographs, anemometers, or any other device for gathering information describing at least one member of a cohort. A multimodal sensor includes a transmission device for communicating the information describing one or more individuals with one or more other multimodal sensors and/or data processing system 100. The multimodal sensor data is used to identify attributes of the individuals. The attributes are used to generate unique cohort groups.

The transmission device may be implemented as any type of device for permitting the exchange of information between multimodal sensors and/or data processing system 100. For example, and without limitation, the transmission device may include a wireless personal area network (PAN), a wireless network connection, a radio transmitter, a cellular telephone signal transmitter, or any other wired or wireless device for transmitting data between multimodal sensors and/or data processing system 100. A wireless personal area network may include, but is not limited to, Bluetooth technologies. A wireless network connection may include, but is not limited to, Wi-Fi wireless technology.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). In addition, data processing system 100 may optionally be implemented as a data processing system in a grid computing system and/or any other type of distributed data processing system.

FIG. 1 is intended as an example, and not as an architectural limitation for the different illustrative embodiments. Network data processing system 100 may include additional servers, clients, sensors, and other devices not shown.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

According to one embodiment of the present invention, a computer implemented method, apparatus, and computer-usable program product for generating unique cohort groups using multimodal sensory device. Multimodal sensory data is received from a set of multimodal sensors in a public environment. The set of multimodal sensors are associated with a network. The multimodal sensory data is received from the set of multimodal sensors over the network. The multimodal sensory data is processed to generate a plurality of attributes to form cohort attributes. A plurality of unique cohort groups is generated using the cohort attributes and the multimodal sensory data. Each member of the cohort group shares at least one common attribute.

Turning now to FIG. 3, a block diagram of a set of multimodal sensors located in a plurality of locations is depicted in accordance with an illustrative embodiment. Public area 300 is an area that is open to the public, viewable by the public, accessible to the public, and/or publicly owned. Business/retail 302-306 are commercial retail establishments, such as a department store, grocery store, clothing store, or any other type of business or retail establishment. Residences 310 are residences, such as single family homes, apartments, condominiums, duplexes, or other types of residences.

Set of sensors 312-320 are sets of multimodal sensors, such as set of multimodal sensors 118 in FIG. 1. Set of sensors 312-320 may be located in any public and/or privately owned locations. In this example, set of sensors 312-320 are located in public area 300. Set of sensors 320 is located in business/retail 304. Thus, in this example, set of sensors 312-320 are located in a combination of public and privately owned spaces. However, set of sensors 312-320 may also be located entirely in public area 300. In another embodiment, set of sensors 312-320 are located in two or more different business/retail establishments, such as business/retail 302-306. Although in this embodiment, set of sensors 312-320 are only located in public spaces, multimodal sensors may optionally also be located in business/retail 304, office space 308, residences 310, and/or any other location.

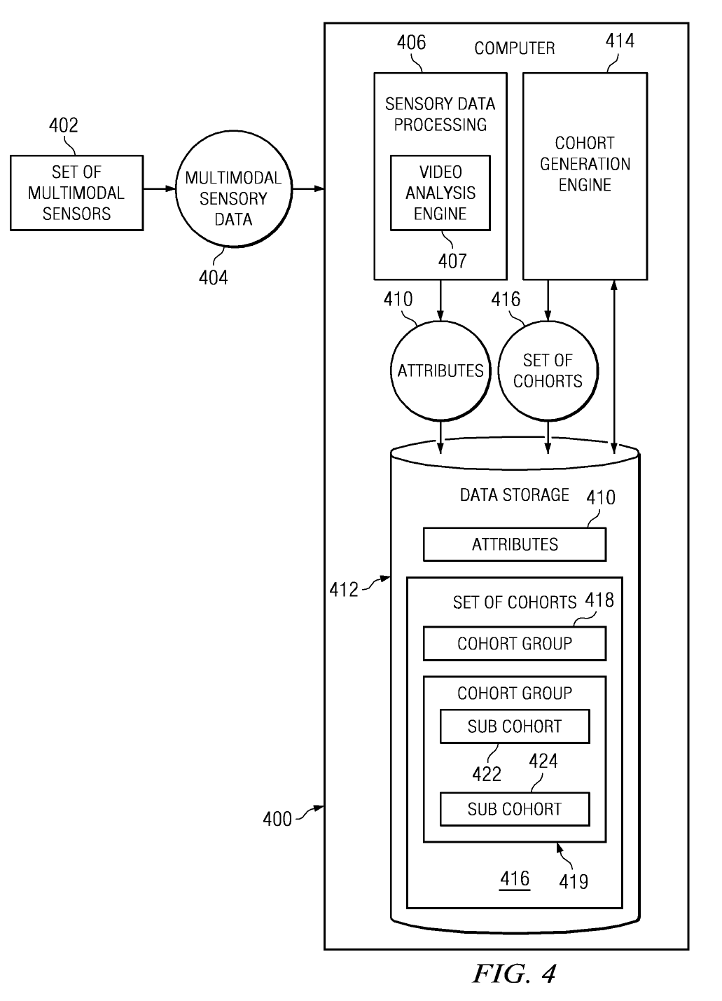

FIG. 4 is a block diagram of a data processing system for generating unique cohort groups using multimodal sensor data in accordance with an illustrative embodiment. Computer 400 may be implemented using any type of computing device, such as a personal computer, laptop, personal digital assistant, or any other computing device depicted in FIGS. 1 and 2.

Set of multimodal sensors 402 is a set of one or more sensors and/or actuators, such as set of multimodal sensors 118 in FIG. 1. Set of multimodal sensors 402 includes sensors having different modes, such as, without limitation, microphone sensors for gathering audio sensor data, cameras for gathering video data, radio frequency identification tag readers for detecting radio frequency signals emitted by radio frequency identification tags, and/or any other type of sensor in a plurality of available multimodal sensors. Multimodal refers to audio, video, infrared, and/or any other mode of sensory data.

Set of multimodal sensors 402 is located in public areas, including, without limitation, indoor locations, outdoor locations, and/or a combination of indoor and outdoor locations. For example, and without limitation, set of locations 402 may include public locations, such as sidewalks, public parking areas, recreation areas, and parks. Set of multimodal sensors 402 generates multimodal sensory data 404. Multimodal sensory data may include, without limitation, a stream of digital video data, still video images, audio data, infrared images, or any other data gathered by one or more sensor devices in set of multimodal sensors 402.

Each sensor in set of multimodal sensors 402 includes a transmitter that permits each sensor to transmit and/or receive data from one or more other sensors in set of multimodal sensors. The transmitter is also used to transmit data to computer 400 and/or receive data from computer 400. The transmitter may be a radio transmitter, a wireless network connection, a WiFi, a Bluetooth transmitter, or any other type of network device for permitting data to be transferred from one device to another. The network is a network such as network 102 in FIG. 1. The network may be implemented as a local area network, a wide area network, an Ethernet, an intranet, the Internet, or any other type of network. The transmitter may optionally include a receiver for receiving data.

In other words, a given sensor in set of multimodal sensors 402 is capable of transmitting sensory data gathered by the given sensor to computer 400 and/or to one or more other sensors in set of multimodal sensors 402. The given sensor may also be capable of receiving instructions from computer 400. The instructions may include instructions to pan, tilt, zoom, change orientation, move, increase a sensitivity of a microphone, decrease a sensitivity of a microphone, cease gathering sensory data, begin gathering sensory data, instructions to transmit sensory data, and/or any other instructions. The given sensor may also receive data from one or more other sensors. The data received from another sensor may include location data identifying the location of one or more other sensors, timing data for synchronizing the gathering of multimodal sensory data 404 by one or more other sensors, and/or exchanging sensory data between the sensors in set of multimodal sensors 402.

Sensory data processing 406 is a software component for processing multimodal sensory data 404 to form attributes 410. Sensory data processing 406 collects sensory data from the sensors and actuators in set of multimodal sensors 402 to form aggregated sensory data. Sensory data processing 406 comprises video analysis engine 407. Video analysis engine 409 is a software component for performing digital video analysis. If set of multimodal sensors 402 includes a set of digital video cameras, the set of digital video cameras captures a stream of video data associated with cohorts. A cohort is a member or potential member of a cohort group, including humans, animals, and/or objects. A cohort may be assigned as a member of no cohort groups, a single cohort group, or two or more cohort groups.

The digital video cameras generate images of one or more cohorts. The images are included in the stream of video data. The set of video cameras transmits the stream of video data to sensory data processing 404 in real time as the stream of video data is generated. In another embodiment, the stream of video data is sent to a data storage device. The video data is then retrieved by sensory data processing 308 for analysis at a later time, rather than receiving the video data in real time. Video analysis engine 407 analyzes the stream of video data and/or audio data using video analytics to generate video metadata describing the cohorts in the stream of video data. Sensory data processing 406 identifies events associated with behaviors of the cohorts using the video metadata and/or audio metadata.

Sensory data processing 406 parses the sensory data to form attributes 410 associated with the cohorts. Attributes 410 may include any type of attribute, characteristic, feature, or event associated with one or more humans, animals, or objects. Attributes 410 may include, without limitation, an individuals age, make and/or model of a vehicle, color of a hat, breed of a dog, sound of an engine, a medical diagnosis, a date of birth, a color, item of clothing, walking, talking, running, a type of food eaten, an identification of an item purchased, or any other attribute associated with a person, animal, or object. An attribute that is an event may include, without limitation, eating, smoking, walking, jogging, walking a dog, carrying bags, carrying a baby, riding a bicycle, an engine running, a baby crying, or any other event. Sensory data processing 406 categorizes the events in accordance with a type of the event. For example, a type of event may include a pace of walking, a companion of the cohort, a time of day a cohort eats a meal, a brand of soda purchased by the cohort, a pet purchased by the cohort, a type of medication taken by the cohort, or any other event.

Attributes 410 are stored in data storage 412. Data storage 412 may be implemented as any type of device for storing data, such as, without limitation, a hard drive, a flash memory, a main memory, read only memory (ROM), a random access memory (RAM), or any other type of data storage device. Data storage may be implemented in a single data storage device or a plurality of data storage devices. Data storage 412 may be a data storage device that is local to computer 400 or a device located remotely to computer 400. If data storage 400 comprises one or more remote data storage device, the remote data storage devices are accessed via a network connection, such as network 102 in FIG. 1. Data storage 412 may be a central data storage. Data storage 412 may also be a de-centralized data storage, such as, without limitation, a grid data processing system, a federated database, and/or any other type of distributed data storage device.

Cohort generation engine 414 is software for generating set of cohorts 416 based on attributes 410. Set of cohorts 416 is a set of one or more unique cohort groups. The unique cohort groups in set of cohorts 416 are generated using attributes 410 that are identified based on multimodal sensory data 404. Cohort group 418 and 419 are cohort groups in set of cohorts 416. Cohort group 418 and cohort group 420 may be a cohort of humans, animals, plants, place, or objects. A cohort group may include one or more sub-cohorts.

A cohort group may include any number of members, from null to an infinite number. In other words, a cohort group may have no members, a single member, or two or more members. Moreover, each sub-cohort may include one or more sub-subcohorts. For example, cohort group 420 in this example includes sub-cohort 422 and sub-cohort 424.

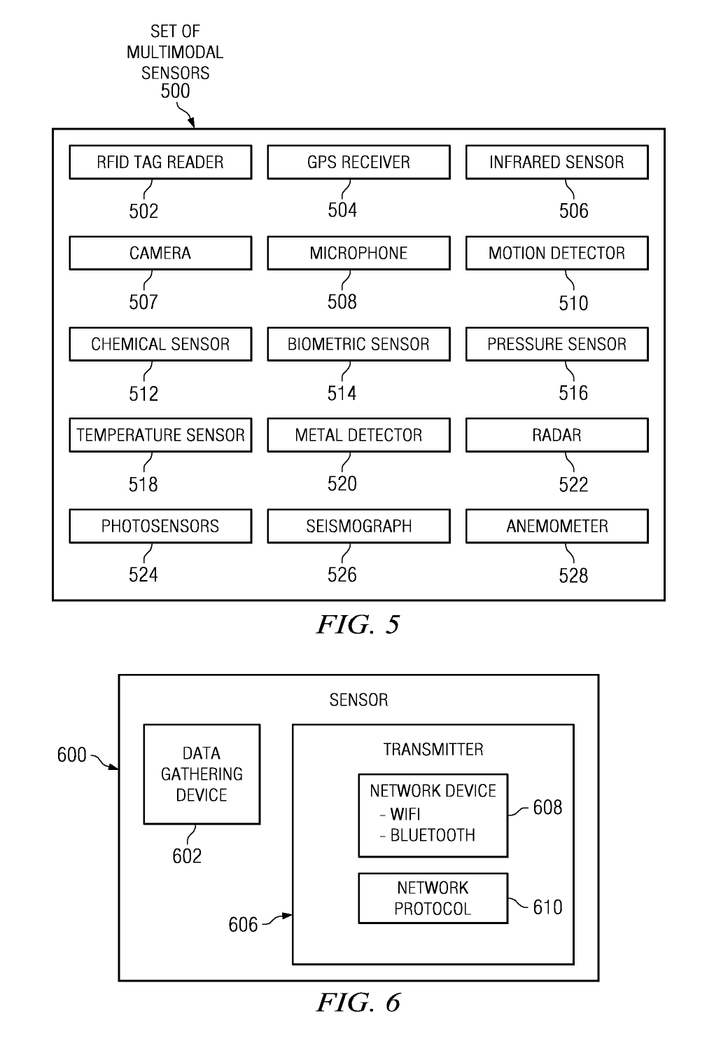

FIG. 5 is a block diagram of a set of multimodal sensors in accordance with an illustrative embodiment. Set of multimodal sensors 500 is a set of one or more sensor and/or actuator devices for generating sensory data, such as set of multimodal sensors 118 in FIG. 1. Set of multimodal sensors 500 may include radio frequency identification (RFID) tag readers, such as RDID tag reader 502. RFID tag reader 502 is a device for receiving data from an active or passive radio frequency identification tag. The radio frequency identification tag may be associated with a product packaging, an object, an identification card, or any other item.

Global positioning system (GPS) receiver 504 is a device for receiving signals from global positioning system satellites to determine a position or location of a person or object. GPS receiver 504 may be located in an object, such as a car, a portable navigation system, a personal digital assistant (PDA), or any other type of object. Infrared sensor 506 is a thermo-graphic camera, also referred to as a forward looking infrared, or an infrared camera, for generating images using infrared radiation. Infrared energy includes the radiation that is emitted by all objects as a function of the object's temperature. Typically, the higher the temperature emitted by an object, the more infrared radiation is emitted by the object. Infrared sensor 506 generates images showing the patterns of infrared radiation associated with heat emitted by people, animals, and/or objects. Infrared sensor 506 operates independently of the presence of visible light. Therefore, infrared sensor 506 can generate infrared images even in total darkness.

Camera 507 is a device for generating images using visible light. Camera 507 is any type of known or available device for capturing images and/or audio, such as, without limitation, an optical image capture device, an infrared imaging device, a spectral or multispectral device, a sonic device, or any other type of image producing device. For example, camera 507 may be implemented as, without limitation, a digital video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area.

Various lenses, filters, and other optical devices such as zoom lenses, wide angle lenses, mirrors, prisms and the like may also be used with camera 507 to assist in capturing the desired view. Camera 507 may be fixed in a particular orientation and configuration, or it may, along with any optical devices, be programmable in orientation, light sensitivity level, focus or other parameters. For example, in one embodiment, camera 507 is capable of rotating, tilting, changing orientation, and panning. In another embodiment, camera 507 is a robot camera or a mobile camera that is capable of moving and changing location, as well as tilting, panning, and changing orientation. Programming data may be provided via a computing device, such as server 104 in FIG. 1.

In this embodiment, camera 507 is located in a fixed location. However, camera 507 is capable of moving and/or rotating along one or more directions, such as up, down, left, right, and/or rotate about an axis of rotation to change a field of view of the camera without changing location of the camera. Camera 507 may also be capable of rotating about an axis to keep a person, animal, vehicle or other object in motion within the field of view of the camera. In other words, the camera may be capable of moving about an axis of rotation in order to keep a moving object within a viewing range of the camera lens.

Camera 507 captures images associated with cohorts within the field of view of camera 507. The cohort may be, without limitation, a person, an animal, a motorcycle, a boat, an aircraft, a cart, or any other type of object.

Camera 507 transmits the video data, including images of cohorts, to a video analysis system for processing into metadata, such as video analysis 310 in FIG. 3. The video data may also include images of identifying features of the object, such as, without limitation, a face of a human user, license plate, an identification badge, a vehicle identification number (VIN), or any other identifying markings or features of the object. An analytics server can then analyze the images to identify the object using license plate recognition analytics, facial recognition analytics, behavior analysis analytics, or other analytics to identify a particular object and/or distinguish one object from another object.

Microphone 508 is any type of known or available device for recording sounds, such as, without limitation, human voices, engine sounds, babies crying, or any other sounds. Motion detector 510 is any type of known or available motion detector device. Motion detector 510 may include, but is not limited to, a motion detector device using a photo-sensor, radar or microwave radio detector, or ultrasonic sound waves. Motion detector 507 may use ultrasonic sound waves transmits or emit ultrasonic sounds waves. Motion detector 507 detects or measures the ultrasonic sound waves that are reflected back to the motion detector. If a human, animal, or other object moves within the range of the ultrasonic sound waves generated by motion detector 507, motion detector 507 detects a change in the echo of sound waves reflected back. This change in the echo indicates the presence of a human, animal, or other object moving within the range of motion detector 507.

In one example, motion detector 507 uses a radar or microwave radio to send out a burst of microwave radio energy and detect the same microwave radio waves when the radio waves are deflected back to motion detector 507. If a human, animal, or other object moves into the range of the microwave radio energy field generated by motion detector 507, the amount of energy reflected back to motion detector 507 is changed. Motion detector 507 identifies this change in reflected energy as an indication of the presence of a human, animal, or other object moving within the range of motion detector 507.

Motion detector 507 may use a photo-sensor. In this example, motion detector 507 detects motion by sending a beam of light across a space into a photo-sensor. The photo-sensor detects when a human, animal, or object breaks or interrupts the beam of light as the human, animal, or object by moving in-between the source of the beam of light and the photo-sensor. These examples of motion detectors are presented for illustrative purposes only. A motion detector in accordance with the illustrative embodiments may include any type of known or available motion detector and is not limited to the motion detectors described herein.

Chemical sensor 512 is a device for detecting the presence of air borne chemicals, such as perfumes, after shave, scented shampoos, scented lotions, and other scents. Biometric sensor 514 is a device for detecting biometric data associated with a cohort. Biometric data includes identifying physiological biometric data, such as, but without limitation, retinal patterns of the eye, iris patterns, fingerprints, thumb prints, and voice prints. Biometric data may also include behavioral biometrics, such as blood pressure, heart rate, body temperature, changes in pupil dilation, or any other physiological changes. Thus, biometric sensor 512 may include a fingerprint scanner, a thumbprint scanner, a retinal eye scanner, an iris scanner, or any other type of biometric device.

Pressure sensor 516 is a device for detecting a change in weight or mass on the pressure sensor. Pressure sensor 516 may be a single pressure sensor or a set of two or more pressure sensors. For example, if pressure sensor 516 is imbedded in a sidewalk, artificial grass, such as Astro Turf, or in a floor mat, pressure sensor 516 detects a change in weight or mass when a human customer or animal steps on the pressure sensor. Pressure sensor 516 may also detect when a human or animal cohort shifts its weight and/or steps off of pressure sensor 516. In another example, pressure sensor 516 is embedded in a parking lot, and pressure sensor 516 detects a weight and/or mass associated with a vehicle when the vehicle is in contact with pressure sensor 516. A vehicle may be in contact with pressure sensor 516 when the vehicle is driving over pressure sensor 516 and/or when a vehicle is parked on top of pressure sensor 516.

Temperature sensor 518 is a device for measuring temperature changes associated with a cohort. For example, temperature sensor 518 may detect the heat emitted by a car engine or the body heat associated with a person or an animal. Metal detector 520 is a device for detecting metal objects. Metal detector 520 may be implemented as any type of known or available metal detection device.

Radar 522, also referred to as radio detection and ranging, uses electromagnetic waves to identify the range, direction, and/or speed of moving objects, such as cars, aircraft, and ships. Radar 522 transmits radio waves toward a target object. The target object may be a member of a cohort group, such as a car, or other object. The radio waves that are reflected back by the target object are detected by Radar 522 and used to measure the speed of the target object. Radar 522 may also include laser radar, also referred to as lidar, ladar, Airborne Laser Swath Mapping (ALSM), and laser altimetry. Laser radar uses light instead of radio waves. Laser radar typically uses short wavelengths of the electromagnetic spectrum, such as ultraviolet and near infrared.

Photosensors 524 is a device for detecting light waves, such as visible light. Seismograph 526 is a device for measuring seismic activity. Anemometer 528 is a device for measuring wind speed. The sensors and actuators in set of multimodal sensors 500 include a transmission device that permits the sensors and actuators to transmit information between the multimodal sensors. In other words, one multimodal sensor can transmit information to another multimodal sensor in set of multimodal sensors. In addition, each multimodal sensor uses the transmitter to transmit sensor data to a software component for processing of the sensory data, such as sensory data processing 308 in FIG. 3.

Turning now to FIG. 6, a block diagram of a sensor in a set of multimodal sensors is depicted in accordance with an illustrative embodiment. Sensor 600 is any type of sensor for gathering information associated with a cohort. The sensor may include any type of sensor in a set of multimodal sensors, such as set of multimodal sensors 118 in FIG. 1 or set of multimodal sensors 500 in FIG. 5.

Sensor 600 comprises data gathering device 602. Data gathering device 602 is a device for gathering sensory data. For example, if sensor 602 is a digital video camera, data gathering device 602 includes the camera lens and image capture technologies associated with the digital video camera. If sensor 600 is an infrared camera, data gathering device 602 comprises the infrared imaging technologies that generate the infrared images.

Sensor 600 includes transmitter 606. Transmitter 606 is a device for transmitting sensor data to a computer for processing and/or transmitting information to one or more other sensors. Transmitter 606 comprises network device 608. Network device 608 is any known or available hardware and/or software for connecting to a network and transmitting and/or receiving data via the network connection, such as, without limitation, a wireless network device, WiFi, a Bluetooth device, a cellular device for enabling communications over a cellular telephone network, or any other type of network device. Network protocol 610 is a set of communications protocols for enabling sensor 600 to communicate information to and from a computing device, such as computer 400 in FIG. 4. Network protocol 610 may also enable sensor 600 to communicate information to and from one or more other sensors in the set of multimodal sensors.

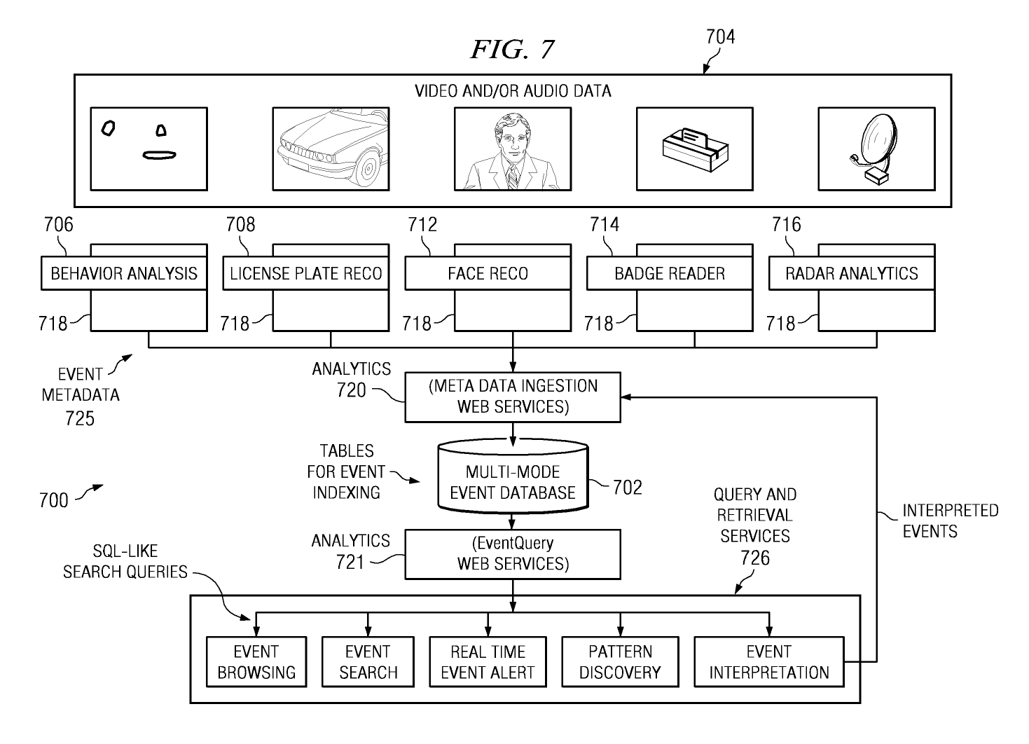

FIG. 7 is a block diagram of a video analysis system in accordance with an illustrative embodiment. Video analysis system 700 is software architecture for generating metadata describing images captured by a set of video cameras, such as video analysis engine 407 in FIG. 4. The metadata generated by video analysis system 700 is used by sensory data processing software to identify attributes of cohorts, such as attributes 410 in FIG. 4.

Video analysis system 700 may be implemented using any known or available software for image analytics, facial recognition, license plate recognition, and sound analysis. In this example, video analysis system 700 is implemented as IBM® smart surveillance system (S3) software.

Video analysis system 700 utilizes computer vision and pattern recognition technologies, as well as video analytics to analyze video images captured by one or more situated cameras and microphones. The analysis of the video data generates events of interest in the environment. For example, an event of interest associated with a cohort at a departure drop off area in an airport includes the position and location of cars, the position and location of passengers, and the position and location of other moving objects. As video analysis technologies have matured, they have typically been deployed as isolated applications which provide a particular set of functionalities.

Video analysis system 700 includes video analytics software for analyzing video images captured by a camera and/or audio captured by an audio device associated with the camera. The video analytics engine includes software for analyzing video and/or audio data 704. In this example, the video analytics engine in video analysis system 700 processes video and/or audio data 704 associated with one or more objects into data and metadata.

Video and/or audio data 704 is data captured by the set of cameras. Video and/or audio data 704 may be a sound file, a media file, a moving video file, a still picture, a set of still pictures, or any other form of image data and/or audio data. Video and/or audio data 704 may also be referred to as detection data. Video and/or audio data 704 may include images of a person's face, an image of a part or portion of a customer's car, an image of a license plate on a car, and/or one or more images showing a person's behavior. An image showing a customer's behavior or appearance may show a customer wearing a long coat on a hot day, a customer walking with two small children which may be the customer's children or grandchildren, a customer moving in a hurried or leisurely manner, or any other type of behavior or appearance attributes of a customer, the customer's companions, or the customer's vehicle.

In this example, video analytics engine 700 architecture is adapted to satisfy two principles. 1) Openness: The system permits integration of both analysis and retrieval software made by third parties. In one embodiment, the system is designed using approved standards and commercial off-the-shelf (COTS) components. 2) Extensibility: The system should have internal structures and interfaces that will permit for the functionality of the system to be extended over a period of time.

The architecture enables the use of multiple independently developed event analysis technologies in a common framework. The events from all these technologies are cross-indexed into a common repository or a multi-mode event database 702 allowing for correlation across multiple audio/video capture devices and event types.

Video analysis system 700 includes the following illustrative analytical technologies integrated into a single system to generate metadata describing one or more objects in an area of interest based on video data from a set of cameras. The analytical technologies are technologies associated with video analytics. In this example, the video analytics technologies comprise, without limitation, behavior analysis technology 706, license plate recognition 708, face detection/recognition technology 712, badge reader technology 714, and radar analytic technology 716.

Behavior analysis technology 706 tracks moving objects and classifies the objects into a number of predefined categories by analyzing metadata describing images captured by the cameras. As used herein, an object may be a human, an object, a container, a cart, a bicycle, a motorcycle, a car, or an animal, such as, without limitation, a dog. Behavior analysis technology 706 may be used to analyze images captured by cameras deployed at various locations, such as, without limitation, overlooking a roadway, a parking lot, a perimeter, or inside a facility.

License plate recognition technology 708 may be utilized to analyze images captured by cameras deployed at the entrance to a facility, in a parking lot, on the side of a roadway or freeway, or at an intersection. License plate recognition technology 708 catalogs a license plate of each vehicle moving within a range of two or more video cameras associated with video analysis system 700. For example, license plate recognition technology 708 is utilized to identify a license plate number on license plate.

Face detection/recognition technology 712 is software for identifying a human based on an analysis of one or more images of the human's face. Face detection/recognition technology 712 may be utilized to analyze images of objects captured by cameras deployed at entryways, or any other location, to capture and recognize faces.

Badge reader technology 714 may be employed to read badges. The information associated with an object obtained from the badges is used in addition to video data associated with the object to identify an object and/or a direction, velocity, and/or acceleration of the object. Events from access control technologies can also be integrated into video analysis system 700.

The data gathered from behavior analysis technology 706, license plate recognition technology 708, face detection/recognition technology 712, badge reader technology 714, radar analytics technology 716, and any other video/audio data received from a camera or other video/audio capture device is received by video analysis system 700 for processing into metadata 725. Event metadata 725 is metadata describing one or more objects in an area of interest.

The events from all the above analysis technologies are cross-indexed into a single repository, such as multi-mode database 702. In such a repository, a simple time range query across the modalities will extract license plate information, vehicle appearance information, badge information, object location information, object position information, vehicle make, model, year and/or color, and face appearance information. This permits video analysis software to easily correlate these attributes. The architecture of video analysis system 700 also includes one or more analytics engines 718, which house event analysis technologies.

Video analysis system 700 further includes middleware for large scale analysis, such as metadata ingestion web services (analytics) 720 and web services analytics (analytics) 721, which provides infrastructure for indexing, retrieving, and managing event metadata 725.

In this example, video and/or audio data 704 is received from a variety of audio/video capture devices, such as set of multimodal sensors 500 in FIG. 5. Video and/or audio data 704 is processed in analytics engine 718.

Each analytics engine 718 can generate real-time alerts and generic event metadata. The metadata generated by analytics engine 718 may be represented using extensible markup language (XML). The XML documents include a set of fields which are common to all engines and others which are specific to the particular type of analysis being performed by analytics engine 718. In this example, the metadata generated by analytics 720. This may be accomplished via the use of, for example, web services data ingest application program interfaces (APIs) provided by analytics 720. The XML metadata is received by analytics 720 and indexed into predefined tables in multi-mode event database 702. This may be accomplished using, for example, and without limitation, the DB2™ XML extender, if an IBM® DB2™ database is employed. This permits for fast searching using primary keys. Analytics 721 provides a number of query and retrieval services based on the types of metadata available in the database.

Retrieval services 726 may include, for example, event browsing, event search, real time event alert, or pattern discovery event interpretation. Each event has a reference to the original media resource, such as, without limitation, a link to the video file. This allows the user to view the video associated with a retrieved event.

Video analysis system 700 provides an open and extensible architecture for dynamic video analysis in real time without human intervention. Analytics engines 718 preferably provide a plug and play framework for video analytics. The event metadata generated by analytics engines 718 is sent to multi-mode event database 702 in any type of programming language files, such as, without limitation, extensible markup language (XML) files. Web services API's in analytics 720 permit for easy integration and extensibility of the metadata. Various applications, such as, without limitation, event browsing, real time alerts, etc. may use structure query language (SQL) or similar query language through web services interfaces to access the event metadata from multi-mode event database 702.

Analytics engine 718 may be implemented as a C++ based framework for performing real-time event analysis. Analytics engine 718 is capable of supporting a variety of video/image analysis technologies and other types of sensor analysis technologies. Analytics engine 718 provides support functionalities for the core analysis components. The support functionalities are provided to programmers or users through a plurality of interfaces employed by analytics engine 718. These interfaces are illustratively described below.

In one example, standard plug-in interfaces may be provided. Any event analysis component which complies with the interfaces defined by analytics engine 718 can be plugged into analytics engine 718. The definitions include standard ways of passing data into the analysis components and standard ways of getting the results from the analysis components. Extensible metadata interfaces are provided. Analytics engine 718 provides metadata extensibility.

For example, consider a behavior analysis application which uses video capture and image analysis technology. Assume that the default metadata generated by this component is object trajectory and object size. If the designer now wishes to add color of the object into the metadata, analytics engine 718 enables this by providing a way to extend the creation of the appropriate structures for transmission to the backend system 720. The structures may be, without limitation, extensible markup language (XML) structures or structures in any other programming language.

Analytics engine 718 provides standard ways of accessing event metadata in memory and standardized ways of generating and transmitting alerts to the backend system 720. In many applications, users will need the use of multiple basic real-time alerts in a spatio-temporal sequence to compose an event that is relevant in the user's application context. Analytics engine 718 provides a simple mechanism for composing compound alerts via compound alert interfaces. In many applications, the real-time event metadata and alerts are used to actuate alarms, visualize positions of objects on an integrated display, and control cameras to get better surveillance data. Analytics engine 718 provides developers with an easy way to plug-in actuation modules which can be driven from both the basic event metadata and by user-defined alerts using real-time actuation interfaces.

Using database communication interfaces, analytics engine 718 also hides the complexity of transmitting information from the analysis engines to multi-mode event database 702 by providing simple calls to initiate the transfer of information.

Analytics 720 and 721 may include, without limitation, a J2EE™ frame work built around IBM's DB2™ and IBM WebSphere™ application server platforms. Analytics 720 supports the indexing and retrieval of spatio-temporal event metadata. Analytics 720 also provides analysis engines with the following support functionalities via standard web services interfaces, such as, without limitation, extensible markup language (XML) documents.

Analytics 720 and 721 provide metadata ingestion services. These are web services calls which allow an engine to ingest events into analytics 720 and 721 system. There are two categories of ingestion services: 1) Index Ingestion Services: This permits for the ingestion of metadata that is searchable through SQL like queries. The metadata ingested through this service is indexed into tables which permit content based searches, such as provided by analytics 720. 2) Event Ingestion Services: This permits for the ingestion of events detected in analytics engine 718, such as provided by analytics 721. For example, a loitering alert that is detected can be transmitted to the backend along with several parameters of the alert. These events can also be retrieved by the user but only by the limited set of attributes provided by the event parameters.

Analytics 720 and/or 721 provide schema management services. Schema management services are web services which permit a developer to manage their own metadata schema. A developer can create a new schema or extend the base middleware for large scale analysis schema to accommodate the metadata produced by their analytical engine. In addition, system management services are provided by analytics 720 and/or 721.

The schema management services of analytics 720 and 721 provide the ability to add a new type of analytics to enhance situation awareness through cross correlation. A marketing model for a monitored retail marketing environment is dynamic and can change over time. For example, marketing strategies to sell soft drinks may be very different in December than in mid-summer. Thus, it is important to permit video analysis system 700 to add new types of analytics and cross correlate the existing analytics with the new analytics. To add/register a new type sensor and/or analytics to increase situation awareness, a developer can develop new analytics and plug them into smart analysis engine 718 and employ middleware for large scale analysis schema management service to register new intelligent tags generated by the new analytics engine analytics. After the registration process, the data generated by the new analytics can become immediately available for cross correlating with existing index data.

System management services provide a number of facilities needed to manage video analysis system 700 including: 1) Camera Management Services: These services include the functions of adding or deleting a camera from a MILS system, adding or deleting a map from a MILS system, associating a camera with a specific location on a map, adding or deleting views associated with a camera, assigning a camera to a specific middleware system server and a variety of other functionality needed to manage the system. 2) Engine Management Services: These services include functions for starting and stopping an engine associated with a camera, configuring an engine associated with a camera, setting alerts on an engine and other associated functionality. 3) User Management Services: These services include adding and deleting users to a system, associating selected cameras to a viewer, associating selected search and event viewing capacities to a user and associating video viewing privilege to a user. 4) Content Based Search Services: These services permit a user to search through an event archive using a plurality of types of queries.

For the content based search services (4), the types of queries may include: A) Search by Time retrieves all events from event metadata 725 that occurred during a specified time interval. B) Search by object presence retrieves the last 100 events from a live system. C) Search by object size retrieves events where the maximum object size matches the specified range. D) Search by object type retrieves all objects of a specified type. E) Search by object speed retrieves all objects moving within a specified velocity range. F) Search by object color retrieves all objects within a specified color range. G) Search by object location retrieves all objects within a specified bounding box in a camera view. H) Search by activity duration retrieves all events from event metadata 725 with durations within the specified range. I) Composite Search combines one or more of the above capabilities. Other system management services may also be employed.

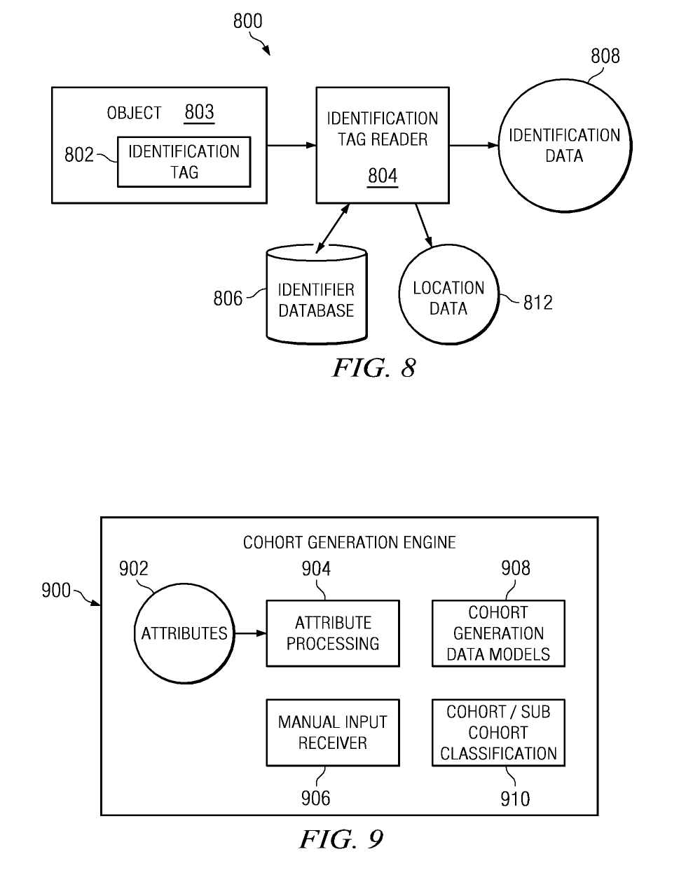

Turning now to FIG. 8, a block diagram of a radio frequency identification tag reader for gathering data associated with one or more cohorts is shown in accordance with an illustrative embodiment. Set of multimodal sensors 800 is a set of multimodal sensors that includes identification tag reader 804. Identification tag reader 804 is a sensor in a set of sensors, such as multimodal sensors 118 in FIG. 1 or set of multimodal sensors 500 in FIG. 5.

Object 803 is any type of object, such as packaging, an item of clothing, a book, or any other object. Identification tag 803 associated with object 803 is a tag for providing information regarding object 803 to identification tag reader 804. In this example, identification tag 802 is a radio frequency identification tag. A radio frequency identification tag includes read-only identification tags and read-write identification tags. A read-only identification tag is a tag that generates a signal in response to receiving an interrogate signal from an item identifier. A read-only identification tag does not have a memory. A read-write identification tag is a tag that responds to write signals by writing data to a memory within the identification tag. A read-write tag can respond to interrogate signals by sending a stream of data encoded on a radio frequency carrier. The stream of data can be large enough to carry multiple identification codes.

In this example, identification tag reader 804 provides identification data 808, and/or location data 812 to a computing device for processing by sensory data processing software, such as sensory data processing 406 in FIG. 4. Identification data 808 may include data regarding the product name, manufacturer name, product description, the regular price, sale price, product weight, tare weight and/or other information describing object 803.

Location data 812 is data regarding a location of object 803. Identifier database 806 is a database for storing any information that may be needed by identification tag reader 804 to read identification tag 802. For example, if identification tag 802 is a radio frequency identification tag, identification tag will provide a machine readable identification code in response to a query from identification tag reader 804. In this case, identifier database 806 stores description pairs that associate the machine readable codes produced by identification tags with human readable descriptors. For example, a description pair for the machine readable identification code “10101010111111” associated with identification tag 802 would be paired with a human readable item description of object 803, such as “orange juice.” An item description is a human understandable description of an item. Human understandable descriptions are for example, text, audio, graphic, or other representations suited for display or audible output.

FIG. 9 is a block diagram of a cohort generation engine in accordance with an illustrative embodiment. Cohort generation engine 900 is software for generating unique cohort groups using attributes identified based on multimodal sensor data, such as cohort generation engine 414 in FIG. 4. Attributes 902 are attributes associated with cohorts. Attributes 902 are identified based on multimodal sensory data, such as multimodal sensory data 404 in FIG. 4. Attribute processing 904 is software for processing attributes to identify and generate unique cohorts. Cohort generation engine 900 optionally includes manual input receiver 906. Manual input receiver 906 may be implemented as hardware and/or software for receiving manual input of attributes from a user.

Cohort generation data models 908 are a set of one or more data models for processing attributes to identify members of cohort groups. Cohort/sub-cohort classification 910 is a software component for classifying unique cohort groups and sub-cohort groups. For example, cohort groups may be classified according to activities or status, such as patients, recipients of a medication, pedestrians, customers, drivers, passengers, shoppers, employees, or any other activities or status. For example, cohort generation engine 900 may use cohort generation data models 908 to generate a cohort group of pedestrians walking dogs, a cohort group of school children, a cohort group of employees working outdoors, a cohort group of employees on smoking breaks, a cohort group of shoppers, a cohort of plants, a sub-cohort of trees, a cohort group of parents with children, a cohort of sidewalks, a cohort of roads, a cohort of parks and recreational areas, a cohort group of male shoppers, a cohort group of female shoppers, or any other type of cohort group. A cohort group may comprise three guys walking down a street in Brooklyn at 3:00 a.m. Cohort generation engine 900 may then use cohort/sub-cohort classification to classify cohorts of shoppers, male cohorts, female cohorts, cohorts of plants, cohorts of animals, and any other classification.

The unique cohort groups are generated using attributes based on multimodal sensory data. The attributes may also, optionally, include attributes received through manual input receiver 906 in addition to the attributes that are automatically generated by the sensory data processing component based on the multimodal sensory data.

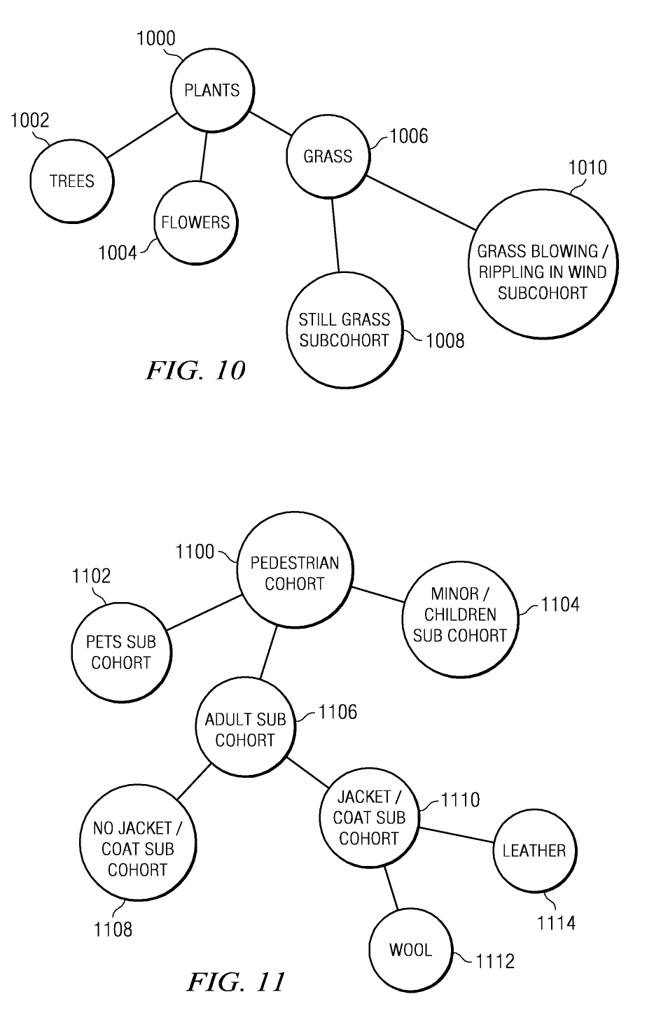

FIG. 10 is a block diagram of a unique plant cohort group in accordance with an illustrative embodiment. Plants 1000 is a cohort group of plants, such as trees, flowers, and grass. Plants 1000 may include one or more sub-cohorts within the plants cohort group, such as, without limitation, trees 1002 sub-cohort group, flowers 1004 sub-cohort group, and/or grass 1006 sub-cohort group. A sub-cohort group may include one or more sub-subcohort groups, such as, without limitation, still grass sub-cohort 1008 and grass blowing/rippling in wind sub-cohort 1010. Still grass sub-cohort 1008 and grass blowing/rippling in wind sub-cohort 1010 are sub-cohorts of grass 1006 and sub-sub-cohorts of plants 1000.

FIG. 11 is a block diagram of a pedestrian cohort group in accordance with an illustrative embodiment. Pedestrian cohort 1100 is a cohort group of pedestrians walking within a given area. Pedestrian cohort 1100 is generated by a cohort generation engine using cohort attributes based on multimodal sensory data, such as attributes 410 in FIG. 4. In this example, pedestrian cohort 1100 comprises pets sub-cohort 1102 of pets walking in the area, adult sub-cohort 1106 group of human adults walking in the given area, and minor/children sub-cohort group 1104 of children walking in the given area. Adult sub-cohort 1106 comprises no jacket/coat sub-cohort 1108 group of cohorts that are not wearing a coat or jacket and jacket/coat sub-cohort 1110 of adult pedestrians that are wearing a coat or jacket. Jacket/coat sub cohort 1110 further includes wool 1112 sub-cohort of adult pedestrians wearing a wool jacket or coat and leather 1114 sub-cohort group of adult pedestrians wearing a leather jacket or leather coat. The cohorts are generated using multimodal sensory data, such as digital video camera data identifying the type of coat or jacket worn by pedestrians, or any other type of sensory data capable of being used to identify the type of coats and/or jackets worn by adult pedestrians in a given area.

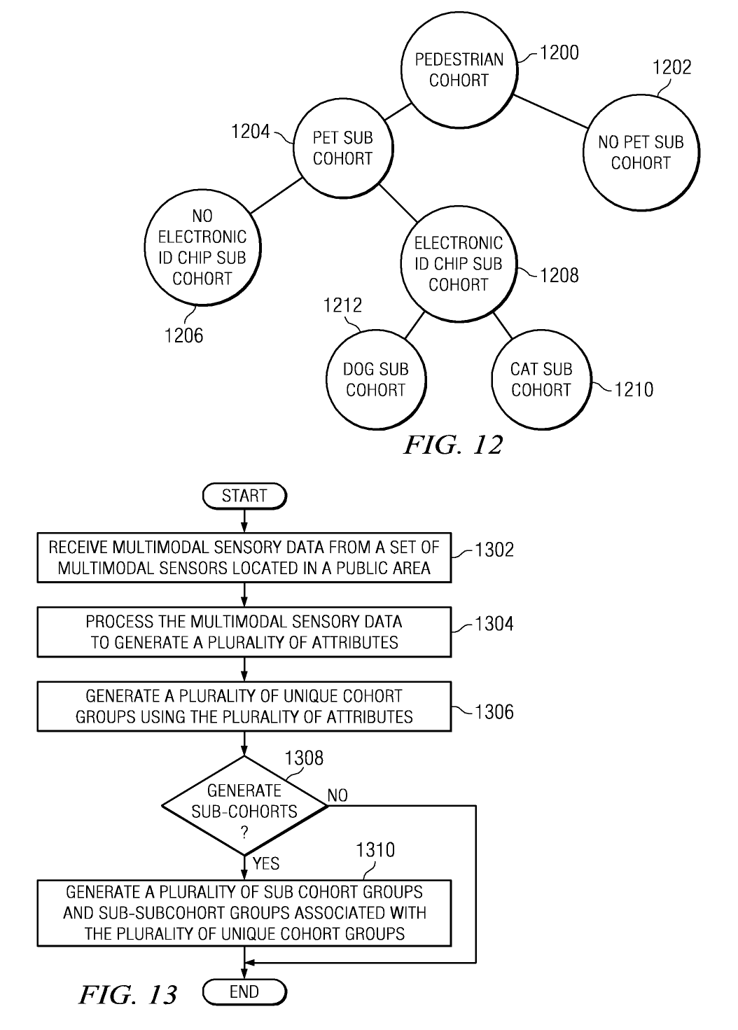

FIG. 12 is a block diagram of another pedestrian cohort group generated using multimodal sensory data in accordance with an illustrative embodiment. Pedestrian cohort 1200 is a cohort group of pedestrians walking in a given area. Pedestrian cohort 1200 is generated using multimodal sensory data transmitted to a central data processing system over a network. In this example, pedestrian cohort 1200 comprises pet sub-cohort 1204 group of pedestrians walking with a pet and no pet sub-cohort 1202 group of pedestrians walking without a pet. Pet sub-cohort 1204 in this example includes, without limitation, no electronic identification chip sub-cohort 1206 of pedestrians walking with pets that do not have an electronic identification chip associated with their pet and electronic identification chip sub-cohort 1208 group of pedestrians walking with a pet that does have an electronic identification chip. The electronic identification chip sub-cohort 1208 may further be divided into a dog sub-cohort 1212 of dogs walking in the given area with an electronic identification chip and cat sub-cohort 1210 of cats having electronic identification chips that are walking in the given area. This information may be used, without limitation, to identify potential customers of pet products and to identify the affluence or amount of spending that a customer may be willing to spend on pet products.

FIG. 13 is a flowchart illustrating a process for generating unique cohort groups using multimodal sensory data transmitted over a network in accordance with an illustrative embodiment. The process in FIG. 13 is implemented by a computing device, such as computer 400 in FIG. 4. Steps 1302-1304 may be performed by software for processing multimodal sensory data to generate cohort attributes, such as sensory data processing 406 in FIG. 4. Steps 1306-1308 may be performed by software that identifies unique cohort groups using cohort attribute data, such as cohort generation engine 414 in FIG. 4.

The process begins by receiving multimodal sensory data from a set of multimodal sensors located in a public area (step 1302). The multimodal sensory data is processed to generate a plurality of attributes associated with a plurality of cohorts (step 1304). A plurality of unique cohort groups are generated using the plurality of attributes (step 1306). A person, animal, plant, plant, place, or object may be a member of more than one cohort group in the plurality of cohort groups. A determination is made as to whether to generate sub-cohort groups (step 1308). If sub-cohorts are not generated, the process terminates thereafter. Returning to step 1308, if sub-cohorts are generated, a plurality of sub-cohort groups and sub-sub-cohort groups are optionally generated and associated with the plurality of unique cohort groups (step 1310) with the process terminating thereafter.

According to one embodiment of the present invention, a computer implemented method, apparatus, and computer-usable program product for generating unique cohort groups using multimodal sensory device. Multimodal sensory data is received from a set of multimodal sensors in a public environment. The set of multimodal sensors are associated with a network. The multimodal sensory data is received from the set of multimodal sensors over the network. The multimodal sensory data is processed to generate a plurality of attributes to form cohort attributes. A plurality of unique cohort groups is generated using the cohort attributes and the multimodal sensory data. Each member of the cohort group shares at least one common attribute.

In this manner, unique cohort data in the form of multimodal sensory data is collected and transmitted via a disparate networked environment for utilization in generating unique cohort groups. The unique cohort group generation using multimodal sensory data enables cohort groups to be generated based on more accurate, up-to-date, and/or using a wider variety of disparate cohort data information sources than prior methods. The cohort generation engine generates cohorts using information from a variety of sensor and actuator devices. Thus, a user can utilize sensory data from an array of multimodal sensor and actuator type devices, such as radio frequency identification, digital video, audio, infrared imaging, and/or any other type of sensors, to understand what individuals might be in a complete customer set.

An array of multimodal sensors may be strategically placed in a given environment. All the sensors in the array of multimodal sensors contain a network device and network protocols that enable the sensors in the array to communicate with each other, as well as with a central data processing system. The multimodal sensory data is then aggregated by the central data processing system in multiple stages to identify customer tastes and potential desires. This data may then become an “entity-network-just-in-time” cohort that is shared between disparate business, retail, and public entities. In other words, the attributes used to generate unique cohort groups may be made available to disparate public and private entities for use in marketing, advertising, medical studies, pharmaceutical plans, community planning and development, development of parks and recreational facilities, and/or any other uses of the cohort groups.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating unique cohort groups using multimodal sensory device, the computer implemented method comprising:
receiving multimodal sensory data from a set of multimodal sensors in a public environment, wherein the set of multimodal sensors are associated with a network, and wherein the multimodal sensory data is received from the set of multimodal sensors over the network;
processing the multimodal sensory data to generate a plurality of attributes to form cohort attributes; and
generating a plurality of unique cohort groups using the cohort attributes and the multimodal sensory data, wherein each member of the cohort group shares at least one common attribute.

2. The computer implemented method of claim 1 wherein the plurality of unique cohort groups further comprises a plurality of sub-cohort groups associated with a set of cohort groups in the plurality of cohort groups.

3. The computer implemented method of claim 1 wherein the set of multimodal sensors comprises a set of radio frequency identification tag readers and further comprising:
receiving information from radio frequency identification tags associated with a set of cohorts by the set of radio frequency identification tag readers, and
transmitting the information over the network to a central data processing system by the radio frequency identification tag readers.

4. The computer implemented method of claim 1 wherein the set of multimodal sensors comprises a set of digital video cameras, wherein the set of digital video cameras captures a stream of video data associated with a set of objects, and wherein the stream of video data is transmitted to a central data processing system in real time as the stream of video data is generated, and further comprising:
analyzing the stream of video data by a video analytics engine associated with the central data processing system to generate video metadata describing the set of objects in the stream of video data; and
identifying the plurality of attributes associated with the set of objects using the video metadata.

5. The computer implemented method of claim 1 wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.

6. The computer implemented method of claim 1 wherein the set of multimodal sensors comprises a set of transmitters for transmitting multimodal sensory data over a network connection to a central data processing system for analysis and a set of network protocols for enabling disparate sensors in the set of multimodal sensors to exchange data over the network.

7. The computer implemented method of claim 1 wherein the set of multimodal sensors comprises an array of sensory devices strategically located within the public environment.

8. The computer implemented method of claim 1 further comprising:
aggregating data gathered by each sensor in the set of multimodal sensors using multimodal sensory data processing, wherein the data comprises information associated with a set of objects, and wherein aggregating the data further comprises:
identifying a type of sensor gathering given data received from each sensor in the set of multimodal sensors;
processing the given data received from each sensor based on the type of sensor gathering the given data; and
analyzing the given data to identify a plurality of attributes associated with the set of objects.

9. The computer implemented method of claim 1 wherein the plurality of unique cohort groups is accessible over the network, and further comprising:
accessing the plurality of unique cohort groups by a plurality of disparate entities from a plurality of disparate client devices over the network.

10. The computer implemented method of claim 2 wherein the plurality of sub-cohort groups associated with a set of cohort groups in the plurality of cohort groups further comprises a set of sub-subcohort groups associated with the plurality of sub-cohort groups.

11. A computer program product for generating unique cohort groups using multimodal sensory device, the computer program product comprising:
a computer readable medium;
program code stored on the computer readable medium for receiving multimodal sensory data from a set of multimodal sensors in a public environment, wherein the set of multimodal sensors are associated with a network, and wherein the multimodal sensory data is received from the set of multimodal sensors over the network;
program code stored on the computer-readable medium for processing the multimodal sensory data to generate a plurality of attributes to form cohort attributes; and
program code stored on the computer-readable medium for generating a plurality of unique cohort groups using the cohort attributes and the multimodal sensory data, wherein each member of the cohort group shares at least one common attribute.

12. The computer program product of claim 11 wherein the set of multimodal sensors comprises a set of radio frequency identification tag readers and further comprising:
program code stored on the computer-readable medium for receiving information from radio frequency identification tags associated with a set of cohorts by the set of radio frequency identification tag readers, and program code stored on the computer-readable medium for transmitting the information over the network to a central data processing system by the radio frequency identification tag readers.

13. The computer program product of claim 11 wherein the set of multimodal sensors comprises a set of digital video cameras, wherein the set of digital video cameras captures a stream of video data associated with a set of objects, and wherein the stream of video data is transmitted to a central data processing system in real time as the stream of video data is generated, and further comprising:
program code stored on the computer-readable medium for analyzing the stream of video data by a video analytics engine associated with the central data processing system to generate video metadata describing the set of objects in the stream of video data; and
program code stored on the computer-readable medium for identifying the plurality of attributes associated with the set of objects using the video metadata.

14. The computer program product of claim 11 wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.

15. The computer program product of claim 11 further comprising:
program code stored on the computer-readable medium for aggregating data gathered by each sensor in the set of multimodal sensors using multimodal sensory data processing, wherein the data comprises information associated with a set of objects, and wherein aggregating the data further comprises:
program code stored on the computer-readable medium for identifying a type of sensor gathering given data received from each sensor in the set of multimodal sensors;
program code stored on the computer-readable medium for processing the given data received from each sensor based on the type of sensor gathering the given data; and
program code stored on the computer-readable medium for analyzing the given data to identify a plurality of attributes associated with the set of objects.

16. An apparatus comprising:
a bus system;
a communications system coupled to the bus system;
a memory connected to the bus system, wherein the memory includes computer usable program code; and
a processing unit coupled to the bus system, wherein the processing unit executes the computer-usable program code to receive multimodal sensory data from a set of multimodal sensors in a public environment, wherein the set of multimodal sensors are associated with a network, and wherein the multimodal sensory data is received from the set of multimodal sensors over the network; process the multimodal sensory data to generate a plurality of attributes to form cohort attributes; and generate a plurality of unique cohort groups using the cohort attributes and the multimodal sensory data, wherein each member of the cohort group shares at least one common attribute.

17. The apparatus of claim 16 wherein the set of multimodal sensors comprises a set of radio frequency identification tag readers, wherein the set of radio frequency identification tag readers receives information from radio frequency identification tags associated with one or more members of the plurality of cohort groups, and wherein the radio frequency identification tag readers transmit the information over the network to a central data processing system.

18. The apparatus of claim 16 wherein the set of multimodal sensors comprises a set of digital video cameras, wherein the set of digital video cameras captures a stream of video data associated with a set of objects, and wherein the stream of video data is transmitted to a central data processing system in real time as the stream of video data is generated, and wherein the processor unit further executes the computer-usable program code to analyze the stream of video data by a video analytics engine associated with the central data processing system to generate video metadata describing the set of objects in the stream of video data; and identify the plurality of attributes associated with the set of objects using the video metadata.

19. The apparatus of claim 16 wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.

20. A data processing system for generating unique cohort groups using multimodal sensory device comprising:
a set of multimodal sensors, wherein each sensor in the set of multimodal sensors comprises a network device that enables the each sensor to communicate using a connection to a wireless network, wherein the each sensor transmits sensor data gathered by the sensor to one or more devices connected to the wireless network, and wherein the each sensor is capable of receiving information from the one or more devices on the wireless network using the network device;
the sensory data processing component, wherein the sensory data processing component multimodal sensory data is received from the set of multimodal sensors over the network, wherein the sensory data processing component processes the multimodal sensory data to generate a plurality of attributes to form cohort attributes; and
a cohort generation engine, wherein the cohort generation engine generates a plurality of unique cohort groups using the cohort attributes and the multimodal sensory data, wherein each member of the cohort group shares at least one common attribute.

21. The data processing system of claim 20 wherein the one or more devices connected to the wireless network comprises at least one sensor in the set of multimodal sensors, and wherein each sensor in the set of multimodal sensors transmits information to the at least one sensor in the set of multimodal sensors using the network device, and wherein the each sensors receives information from the at least one sensor in the set of multimodal sensors using the network device.

22. The data processing system of claim 20 further comprising:
the set of multimodal sensors, wherein the set of multimodal sensors comprises a set of digital video cameras, and wherein the set of multimodal sensors transmits a stream of video data associated with the cohort group to the sensory data processing engine in real time as the stream of video data is captured by the set of digital video cameras to form the sensory data.

23. The data processing system of claim 20 further comprising:
the set of multimodal sensors, wherein the set of multimodal sensors comprises a set of radio frequency identification tag receivers.

24. The data processing system of claim 20 wherein the sensory data processing engine further comprises:
a video analysis system, wherein the video analysis system analyzes a stream of video data received from at least one digital video camera in the set of multimodal sensors, wherein the video analysis system generates metadata describing contents of the stream of video data, and wherein the sensory data processing engine identifies events associated with behavior of cohorts using the metadata.

25. The data processing system of claim 20 further comprising:
the set of multimodal sensors, wherein the set of multimodal sensors comprises at least one of a set of global positioning satellite receivers, a set of infrared sensors, a set of microphones, a set of motion detectors, a set of chemical sensors, a set of biometric sensors, a set of pressure sensors, a set of temperature sensors, a set of metal detectors, a set of radar detectors, a set of photosensors, a set of seismographs, and a set of anemometers.
